(19) United States
(12) Patent Application Publication
(10) Pub. No.: US 2007/0125699 A1
(43) Pub. Date: Jun. 7, 2007

(54) Filter Device

(76) Inventor: Charles C. Hendee, Missouri City, TX (US)

Correspondence Address: BUSKOP LAW GROUP, P.C., 1776 YORKTOWN, SUITE 550, HOUSTON, TX, 77056, US

(21) Appl. No.: 11/566,558

(22) Filed: Dec. 4, 2006

Related U.S. Application Data
(60) Provisional application No. 60/741,814, filed on Dec. 2, 2005.

(51) Int. Cl. B01D 35/28

(52) U.S. Cl. 210/452

(57) ABSTRACT

A filtering apparatus, including a flexible mesh filter and a compressible gasket, for use in filtering low viscosity liquids in a flexible tubular conduit. The filtering apparatus can include a threadable coupling for connection between a first port and a second port, and a flexible mesh secured to a flexible and compressible gasket. A quality assurance device for transporting a fluid conduit, which can include a gasket with filter assembly, and a coupling body for housing the gasket with filter assembly connectable to the fluid conduit.

### CROSS REFERENCE TO RELATED APPLICATIONS

The present application claims priority to co-pending U.S. Provisional Patent Application Ser. No. 60/741,814 filed on Dec. 2, 2005.

### FIELD

The embodiments relate to fluid filters that operate as a compressible mesh and gasket assembly to be utilized in the transport of liquids, such as gasoline, or other fluids generally clear of particulates.

### BACKGROUND

Filtration systems are often used to remove particulate matter and other foreign matter from liquids. To filter a liquid supply, the liquid must be passed though a mesh to remove particles and foreign matter having a diameter greater than the aperture size of the mesh. A problem with such a system is that the mesh quickly becomes blocked with the particles and foreign matter removed from the liquid supply. In addition, dependant on the fluid being filtered, spills and leaks of liquids can occur on the surrounding surface area during the filtration process, which can create a biohazard.

One solution in the art incorporates a filtering chamber surrounded by a small aperture mesh. Liquid is drawn through the unit, through the mesh, and out an outlet pipe by means of a pump. A tapping of filtered liquid from the pumped outlet of the filter chamber is then diverted via a return conduit into a back washing nozzle assembly in the form of a rotatable impeller. The liquid is spread from outlets of the impeller against the interior face of the mesh in the hope of dislodging particles and debris on the exterior face of the mesh. This solution however, suffers from a number of drawbacks. Most importantly the system is not in-line; spills and leaks can occur around the surrounding surface during the filtration process, which can create a biohazard.

Another solution in the art proposes a filter unit used for filtering particulates and other foreign matter from a fluid supply. A dedicated pump is used to pump fluid from the filtering chamber exclusively through a rotatable member located within the filtering chamber to exit through at least one outlet of the rotatable member to impinge on an interior face of the mesh so as to dislodge particulates and other foreign matter located on an exterior face of the mesh. This filter unit still suffers the drawback of not being in-line. Thus, spillage and leakage of liquid can still occur when transferring fluids in and out of the tank.

A need exists for a filter unit for filtering particulates and other foreign matter from a fluid supply that is in-line, thereby preventing spillage and leakage of liquid onto the ground during the transfer of fluids in and out of the tank.

The present embodiments meet this need.

### SUMMARY

The embodiments relate to a filtering apparatus for use in a flexible tubular conduit that can provide a component adaptable for use in tanks, such as one in a truck, tanker truck, or other transportation vessel. A low viscosity liquid, such as water, gasoline, white oil, coolant, lubricant, or others, can be filtered through the filtering apparatus. In an embodiment, a coupling is used to connect the filter to the inlet port of a tank incorporated with a truck, tanker truck, or other transportation vessel. The flexible tubular conduit incorporates a flexible mesh filter and a non-deformable compressible gasket. The flexible mesh filter can be a conical shape with a pore size ranging from about 20 microns to about 500 microns. The compressible gasket is secured and supported by the flexible mesh filter to form a seal with the coupling.

The embodiments relate to gaskets and filtering assemblies for a low viscosity liquid. In an embodiment, a threadable coupling connects to an inlet port of a tank, such as one in a tanker truck or other transportation vessel, for connection between a first port and a second port. A flexible conical mesh comprising a mesh with a pore size ranging from about 20 microns to about 500 microns is secured to a flexible compressible gasket disposed within the threadable coupling in a leak tight fashion. A low viscosity liquid is filtered from the first port to the second port. The low viscosity can be a liquid such as water, gasoline, white oil, coolant, lubricants, and others.

The embodiments provide quality assurance devices for use in transporting a fluid conduit with a gasket, a filter assembly, and a coupling body. The coupling body is used for housing the gasket with the filter assembly connectable to the fluid conduit. The fluid conduit is an inlet port of a tank, such one in a tanker truck or other transportation vessel.

### BRIEF DESCRIPTION OF THE DRAWINGS

The detailed description will be better understood in conjunction with the accompanying drawings as follows:

FIG. 1 depicts a cross-sectional view of a filter apparatus of an embodiment.

FIG. 2 depicts a cross-sectional view of a filter apparatus of an embodiment.

FIG. 3 depicts a cross sectional view of the filter apparatus in a coupling, according to an embodiment.

The present embodiments are detailed below with reference to the listed Figures.

### DETAILED DESCRIPTION OF THE EMBODIMENTS

Before explaining the present embodiments in detail, it is to be understood that the embodiments are not limited to the particular embodiments and that they can be practiced or carried out in various ways.

The embodiments are directed towards a recyclable in-line filtering apparatus for use in filtering of fluid without spillage and leakage of liquids, which can create a biohazard.

The filtering apparatus for use in a coupling of a flexible tubular conduit can provide a component adaptable for use in tanks, specifically tanks for trucking and other transport vessels, which enables low viscosity fluid to be filtered using different mesh sizes. In an embodiment, a relatively thin screened filter component can be used, having minimal fluid flow restriction. The embodiment can additionally provide an apparatus for housing a filter component for use in in-line filling of fluid in tanks, specifically tanks for trucking and other transport vessels. The filter housing apparatus can operate as a coupling in connecting the filter and the tank.

A relatively thin screened filter component with a minimal fluid flow restriction can be utilized. The embodiment can include a mesh filter component for use in filtering fluid. The mesh filter can be fabricated from polymeric and metal monofilaments. The mesh filter is contemplated to be of a size that is large enough to allow the fluid to transfer into the tank, yet small enough to remove particles and foreign matter. The mesh of the filter can have a pore size ranging from about 20 microns to about 500 microns.

The embodiments relate to a filtering apparatus for use in a coupling for a flexible tubular conduit, such as to a tanker truck or other vessels. The recyclable filtering apparatus can include a conical flexible mesh filter and a compressible gasket for supporting the flexible mesh filter and forming a seal within the coupling.

The gasket can be a synthetic rubber, a natural rubber, an elastomeric blend of materials, or combinations thereof. The gasket can be capable of deforming and providing a sealing engagement in a coupling which attaches to a hose that can sustain a liquid pressure ranging from about 1 psi to about 200 psi.

The filter can be conical in shape or can be cylinder in shape, so long as the filter has no openings other than the pores of the filter. The filter can be secured to the gasket either in two parts, or as a single structure.

The embodiments relate to gasket and filter assemblies for a low viscosity liquid, such as water, gasoline, or other liquids. The gasket and filter assembly can include a threadable coupling disposed between a first and second hose, and a flexible conical mesh secured to a flexible and compressible gasket disposed within the coupling. The gasket is capable of creating a proper seal of the coupling.

The filtering assemblies can connect to the inlet or outlet ports of tanks, trucks, tanker trucks, and other transportation vessels. The mesh of the filter preferably can have a pore size ranging from about 20 microns to about 500 microns. The filter can be used for the quality assurance of the liquid being transported. The liquid should normally be free of particulates. In one embodiment, such as for water, the filter can have a pore size of about 400 microns. The fluid to be filtered can be a low viscosity liquid, such as water, gasoline, white oil, coolant, a lubricant, or other liquids. The filter may be reusable or maintained on file for quality assurance purposes.

The embodiments relate to quality assurance devices for use in a fluid conduit. The quality assurance device can include a gasket with a filter assembly, and a coupling body for housing the gasket with filter assembly connectable to the fluid conduit.

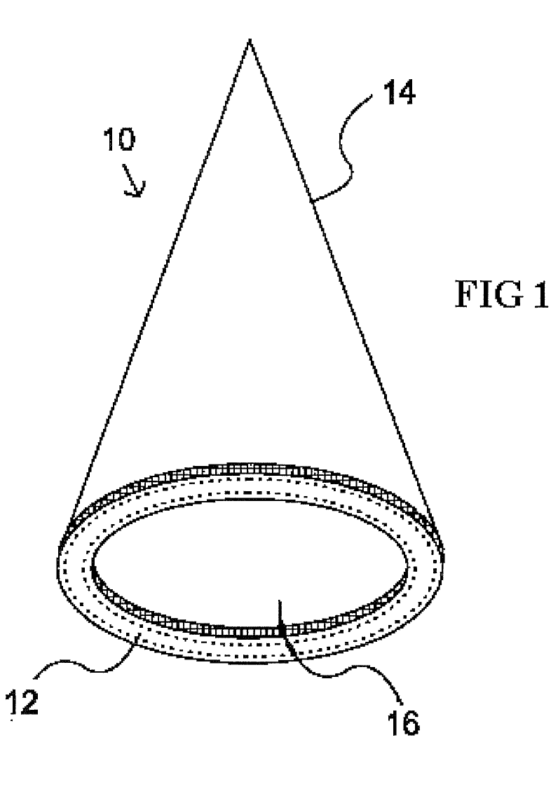

With reference to the figures, FIG. 1 depicts a cross-sectional view of an embodiment of the filter apparatus (10). A filter apparatus (10) can include a gasket (12) and a mesh filter (14) secured to the gasket (12). The gasket (12) and the mesh filter (14) can be configured to be selectively engageable with one another, though the filter apparatus can comprise a single component.

The mesh of the mesh filter (14) can be a porous filter. For example, a mesh polypropylene or a mesh polyethylene can be utilized in an embodiment of the filter apparatus (10). Mesh nylon can also be used in the mesh filter. Alternatively, a metal, such as a sintered polytetrafluoroethylene (PTFE), stainless steel, and titanium, can be used in the present embodiment.

The gasket (12) can be circular to form a seal within a coupling for loading fluid into a tanker truck. The gasket (12) has an opening (16) which can be encircled by the mesh filter (14). The mesh filter (14) can be conical in shape and secured to the gasket (12). All portions of the fluid passing through the gasket (12) are filtered through the mesh filter (14). There are no openings in the mesh filter (14) other than the pores in the mesh filter (14) and the opening (16) created by the gasket (12).

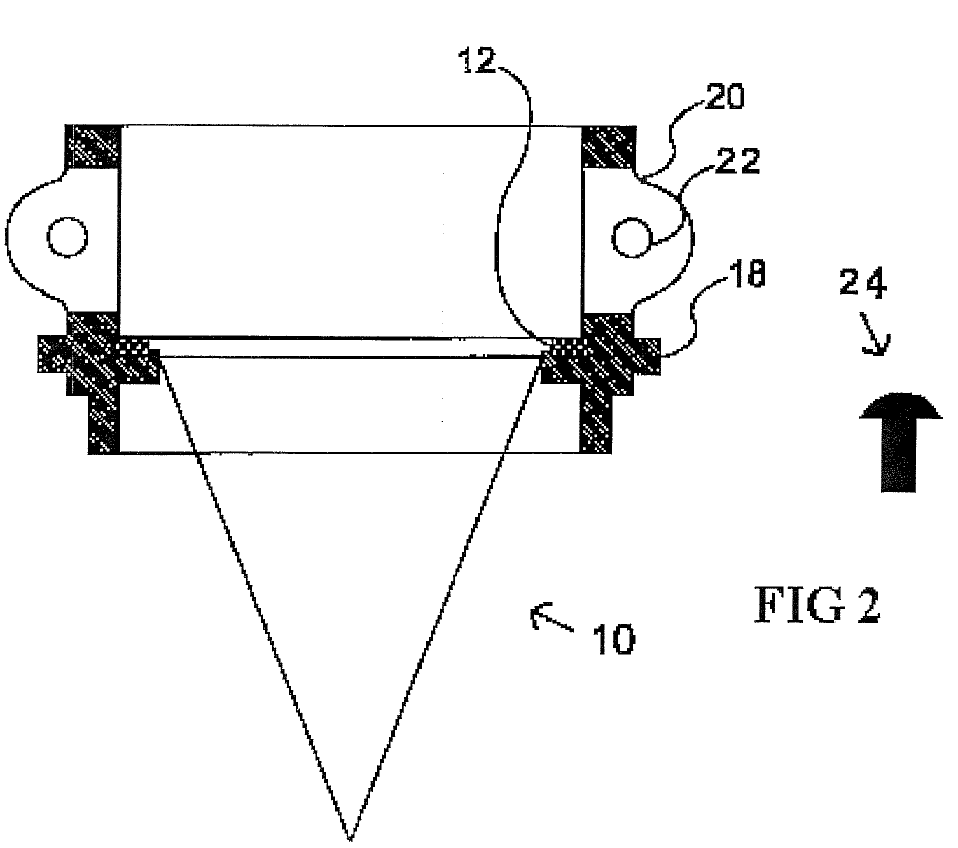

FIG. 2 depicts a cross-sectional view of the filter apparatus in conjunction with a fluid coupling. The gasket (12) of the filter apparatus (10) is connected with the coupling device (18). Incorporated within the coupling is a flange (20) for connecting the coupling to the tank of a truck, tanker truck or other transportation vessel. A hole (22) in the flange (20) is used for receiving a fastener (24) to the inlet port of the tank of a truck, tanker truck or other transportation vessel.

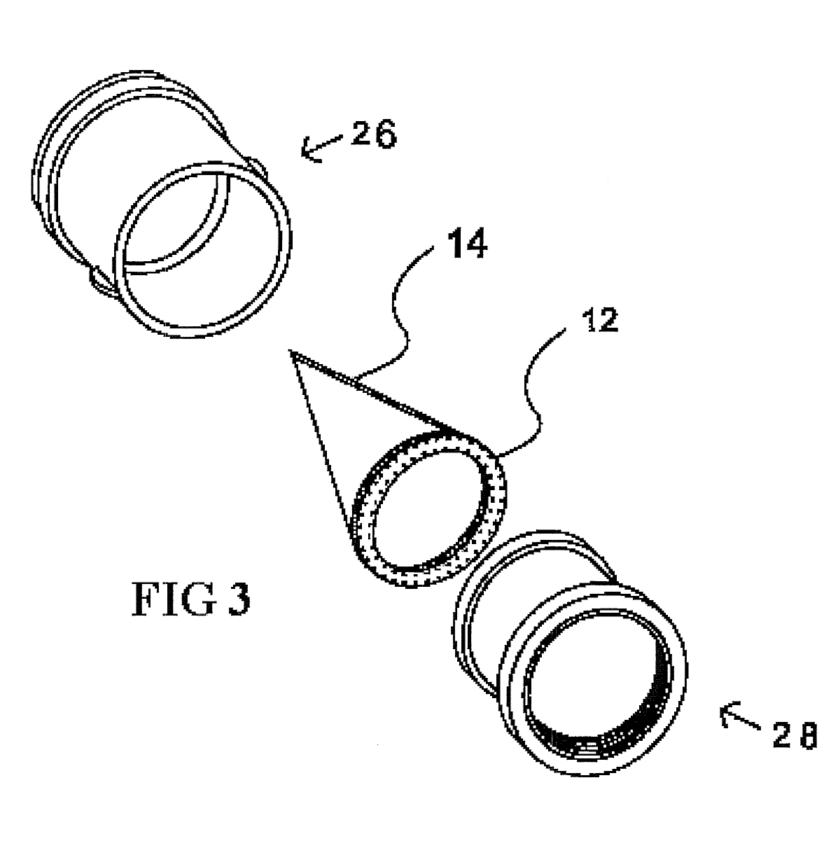

FIG. 3 is an exploded view of the gasket (12) and mesh filter (14) contained in a fluid coupling (26), which can be secured to a tank of a truck, tanker truck, or other transportation vessel. A conical insert (28) is used to ensure the flow of liquid through the filter apparatus.

While these embodiments have been described with emphasis on the embodiments, it should be understood that within the scope of the appended claims, the embodiments might be practiced other than as specifically described herein.

What is claimed is:

1. A filtering apparatus for use in a flexible tubular conduit to a tanker truck comprising:
a. a flexible mesh filter, and
b. a compressible gasket;
wherein the filtering apparatus connects to an inlet port of the tanker truck, and the flexible mesh filter is a conical shape and filters particles with a pore size from about 20 microns to about 500 microns.

2. The filtering apparatus of claim 1, wherein the filtering apparatus is reusable and recyclable.

3. The filtering apparatus of claim 1, wherein the filtering apparatus is used to filter a low viscosity liquid.

4. The filtering apparatus of claim 3, wherein the low viscosity liquid is water, gasoline, white oil, coolant, or a lubricant.

5. The filtering apparatus of claim 1, wherein the compressible gasket is secured to and supports the flexible mesh filter to form a seal.

6. The filtering apparatus of claim 1, wherein the flexible mesh filter filters particles with a pore size of about 400 microns.

7. The filtering apparatus of claim 1, wherein the compressible gasket is non-deformable.

8. A filtering assembly for a low viscosity liquid, comprising:
a. a threadable coupling for connection between a first port and a second port; and
b. a flexible conical mesh secured to a flexible compressible gasket;
wherein the filtering assembly connects to an inlet port of the tanker truck, and the filtering assembly filters particles with a pore size from about 20 microns to about 500 microns.

9. The filtering assembly of claim 8, wherein the filtering assembly is reusable and recyclable.

10. The filtering assembly of claim 8, wherein the filtering assembly is used to filter a low viscosity liquid.

11. The filtering assembly of claim 10, wherein the low viscosity liquid is water, gasoline, white oil, coolant, or a lubricant.

12. The filtering assembly of claim 8, wherein the flexible compressible gasket is secured to and supports the flexible conical mesh to form a seal within the filtering assembly.

13. The filtering assembly of claim 8, wherein the flexible conical mesh filters particles with a pore size of about 400 microns.

14. A quality assurance device for use in transporting a fluid conduit comprising:
a. a gasket with a filter assembly; and
b. a coupling body for housing the gasket with the filter assembly connectable to the fluid conduit;
wherein the gasket is certified to an ASTM standard to filter particles with a diameter from about 20 microns to about 500 microns, and the fluid conduit is an inlet port of a tanker truck.

15. The quality assurance device of claim 14, wherein the quality assurance device is reusable and recyclable.

16. The quality assurance device of claim 14, wherein the quality assurance device is used to filter a low viscosity liquid.

17. The quality assurance device of claim 16, wherein the low viscosity liquid is water, gasoline, white oil, coolant, or a lubricant.

18. The quality assurance device of claim 14, wherein the gasket is secured to and supports the filter assembly to form a seal within the coupling body.

19. The quality assurance device of claim 14, wherein the filter assembly filters particles with a pore size of about 400 microns.
